(19) United States
(12) Patent Application Publication
(10) Pub. No.: US 2025/0063239 A1
(43) Pub. Date: Feb. 20, 2025

(54) ARTIFICIAL INTELLIGENCE ASSISTED INTERVIEW SYSTEM FOR GENERATING AND QUERYING INTERACTIVE VIDEOS

(71) Applicant: StoryFile, Inc., Los Angeles, CA (US)

(72) Inventors: Samuel Michael Gustman, Los Angeles, CA (US); Andrew Victor Jones, Los Angeles, CA (US); Michael Glenn Harless, Los Angeles, CA (US); Stephen David Smith, Los Angeles, CA (US); Heather Lynn Smith, Los Angeles, CA (US); Radoslav Momchilov Petkov, Los Angeles, CA (US)

(73) Assignee: StoryFile, Inc., Los Angeles, CA (US)

(21) Appl. No.: 18/616,100

(22) Filed: Mar. 25, 2024

Related U.S. Application Data
(60) Provisional application No. 63/492,174, filed on Mar. 24, 2023.
(60) Provisional application No. 63/560,485, filed on Mar. 1, 2024.

(51) Int. Cl. H04N 21/8545; G06F 16/332; G06Q 10/1053; G10L 15/26

(52) U.S. Cl. CPC H04N 21/8545; G06F 16/3329; G06Q 10/1053; G10L 15/26

(57) ABSTRACT

Example systems, methods, and non-transitory computer readable media are directed to an AI-assisted interview system that provides real-time analysis and suggestions during video and audio interviews. The system can analyze questions, response text, audio, and video in real-time and suggest follow-up topics and questions. Suggested topics and questions can optimize for breadth by sampling under-sampled semantic regions and/or depth by identifying related questions. The system can provide clarification suggestions for ambiguous responses and measure quality metrics for questions and answers.

### CROSS-REFERENCE TO RELATED APPLICATION

The present patent application claims priority from, and is a non-provisional application of, U.S. Provisional Patent Application No. 63/492,174, entitled “Cascading Artificial Intelligence Based Interactive Interview Assistant,” filed Mar. 24, 2023, which is incorporated by reference herein.

### FIELD OF THE INVENTION(S)

Embodiments of the present inventions relate generally to an artificial intelligence assisted interview system for generating and querying interactive videos.

### BACKGROUND

Conducting interviews can be challenging, especially when it comes to extracting detailed and meaningful information from the interviewee. Not all people are natural storytellers, which can make it difficult for them to articulate their experiences, thoughts, and ideas in a clear and coherent manner. This challenge is further compounded when interviewing experts, as they often internalize their knowledge through years of practice and automation. This internalization can make it difficult for experts to consciously access and communicate the underlying processes and thought patterns that contribute to their expertise. Moreover, experts may struggle to convey their knowledge in a way that is accessible to novices. This is because experts often take for granted the knowledge and skills that they have acquired over time and may assume that others possess the same level of understanding.

### SUMMARY

Example systems, methods, and non-transitory computer readable media are directed to provide a graphical user interface (GUI) through which information describing an interviewee to be interviewed is specified, wherein the GUI is accessible to an interviewer conducting the interview; generate a prompt for a large language model (LLM) that requests a customized set of questions to ask the interviewee during the interview based at least in part on the information describing the interviewee; obtain an output from the LLM in response to the generated prompt, wherein the output provides the customized set of questions to ask the interviewee during the interview; record a plurality of segments of the interviewee answering questions from the customized set of questions, wherein a segment corresponds to a video recording of the interviewee while answering a given question from the customized set of questions; and generate an interactive video of the interview, wherein the interactive video comprises the plurality of segments that are video recordings of the interviewee answering questions from the customized set of questions.

According to some embodiments, the GUI includes a form to specify at least one of a name of the interviewee, a biography of the interviewee, topics of interest, a target user audience, a number of questions to be generated by the LLM, question length, or question tone.

According to some embodiments, the prompt generated to request the customized set of questions from the LLM identifies at least a name of the interviewee, a biography of the interviewee, a topic of interest, a target user audience, and a number of questions to be generated by the LLM.

According to some embodiments, the customized set of questions generated by the LLM are provided in the GUI, and wherein the GUI is accessible to the interviewer while conducting the interview.

According to some embodiments, recording a plurality of segments of the interviewee answering questions from the customized set of questions includes: storing a segment associated with a question answered by the interviewee, wherein the segment corresponds to a video recording of the interviewee while answering the question; generating a second prompt for the LLM that requests one or more follow-up questions to ask the interviewee in response to the question answered by the interviewee; obtaining a second output from the LLM in response to the second prompt, wherein the second output provides the one or more follow-up questions to ask the interviewee.

According to some embodiments, the second prompt to request the one or more follow-up questions includes at least a transcription of the segment associated with the question answered by the interviewee.

According to some embodiments, recording a plurality of segments of the interviewee answering questions from the customized set of questions includes: determining a transcription of a segment, wherein the segment corresponds to a video recording of the interviewee while answering a question; analyzing the transcription of the segment to determine a tone of the interviewee while answering the question; determining, based on the tone of the interviewee, to re-phrase the customized set of questions; generating a second prompt for the LLM that requests a re-phrasing of the customized set of questions based at least in part on the tone of the interviewee; and obtaining a second output from the LLM in response to the second prompt, wherein the second output provides the customized set of questions that are re-phrased based on the tone of the interviewee.

According to some embodiments, recording a plurality of segments of the interviewee answering questions from the customized set of questions includes: determining a transcription of a segment, wherein the segment corresponds to a video recording of the interviewee while answering a question; analyzing the transcription of the segment to determine one or more ambiguities in the answer provided by the interviewee; generating a second prompt for the LLM that requests one or more clarifying questions based at least in part on one or more ambiguities in the answer provided by the interviewee; and obtaining a second output from the LLM in response to the second prompt, wherein the second output provides the one or more clarifying questions.

According to some embodiments, recording a plurality of segments of the interviewee answering questions from the customized set of questions includes: storing a segment associated with a question answered by the interviewee, wherein the segment corresponds to a video recording of the interviewee while answering the question; determining an amount of time remaining for the interview; and ranking questions remaining in the customized set of questions based at least in part on the amount of time remaining for the interview.

According to some embodiments, generating the interactive video of the interview includes generating an index for the interactive video based on segments recorded during the interview, wherein the index maps a segment, one or more semantic vector encodings of questions answered during the segment, and a timestamp corresponding to the segment in the interactive video.

Example systems, methods, and non-transitory computer-readable media are directed to determine a request for an interactive video, wherein the interactive video comprises a plurality of segments of an interviewee answering questions during an interview and wherein a segment corresponds to a video recording of the interviewee while answering a given question; provide a graphical user interface (GUI) that includes an interactive video player for accessing the interactive video; determine a question provided by a user of the GUI; determine a segment from the plurality of segments that is responsive to the question provided by the user; and provide the segment for presentation in the interactive video player included in the GUI.

According to some embodiments, the question is provided as text in a field provided in the GUI.

According to some embodiments, determining a segment from the plurality of segments that is responsive to the question provided by the user includes determining a semantic vector encoding of the question provided by the user and matching the semantic vector encoding of the question provided by the user to a segment in the plurality of segments.

According to some embodiments, matching the semantic vector encoding of the question provided by the user to a segment in the plurality of segments includes accessing an index associated with the interactive video, wherein the index maps segments, one or more semantic vector encodings of questions answered during the segments, and timestamps corresponding to the segments in the interactive video and determining a shortest cosine similarity distance between the semantic vector encoding of the question provided by the user and a semantic vector encoding associated with the segment.

According to some embodiments, the systems, methods, and non-transitory computer readable media may determine that no segments in the interactive video are responsive to the question provided by the user, and generate a response to the question asked by the user based at least in part on a retrieval augmented generation (RAG) technique that attempts to answer the question based on documents associated with the interactive video.

### BRIEF DESCRIPTION OF THE DRAWINGS

FIG. 1 depicts a block diagram of an example approach for accessing and querying an interactive video according to some embodiments.

FIG. 2 depicts a block diagram of components of an artificial intelligence (AI) assisted interview system according to some embodiments.

FIG. 3 depicts a block diagram of an example approach for generating an interactive video according to some embodiments.

FIG. 4 depicts a block diagram of an example approach for interacting with an interactive video according to some embodiments.

FIGS. 5A-5G depict example graphical user interfaces for generating interactive videos according to some embodiments.

FIGS. 6A-6C depict example graphical user interfaces for accessing interactive videos according to some embodiments.

FIG. 7A illustrates an example process according to some embodiments.

FIG. 7B illustrates another example process according to some embodiments.

FIG. 8 is a block diagram illustrating a computing (or digital) device in one example.

### DETAILED DESCRIPTION

Conducting interviews can be challenging, especially when it comes to extracting detailed and meaningful information from the interviewee. Not all people are natural storytellers, which can make it difficult for them to articulate their experiences, thoughts, and ideas in a clear and coherent manner. This challenge is further compounded when interviewing experts, as they often internalize their knowledge through years of practice and automation. This internalization can make it difficult for experts to consciously access and communicate the underlying processes and thought patterns that contribute to their expertise. Moreover, experts may struggle to convey their knowledge in a way that is accessible to novices. This is because experts often take for granted the knowledge and skills that they have acquired over time and may assume that others possess the same level of understanding.

To address these challenges, in various embodiments, there is a need for an AI-assisted interview system that can help generate questions specific to the interviewee. The AI-assisted interview system may use natural language processing and machine learning algorithms to analyze interviewee's responses and adapt the questions accordingly. The adaptation of the questions may involve re-ranking the order in which questions are asked during the interview or generating new follow-up questions to fill informational gaps during the interview. For example, if the interviewee is having difficulty articulating a particular concept, the AI-assisted interview system could provide follow-up questions to help elicit more detailed information. Additionally, the AI-assisted interview system may use sentiment analysis to detect the interviewee's emotional state and adjust the tone and style of the questions to create a more comfortable and engaging interview experience. By providing personalized and targeted support, the AI-assisted interview system could help to overcome the challenges associated with interviewing both novices and experts and facilitate more effective knowledge transfer and communication.

In various embodiments, interviews produced using the AI-assisted interview system may be stored as interactive videos (or storyfiles). Interactive videos may be accessed via an interactive video player. An interactive video may be a digital recording of an interview (or conversation) between an interviewer and interviewee. The interactive video may be made up of one or more segments. Each segment may correspond to a portion of the interview where a particular question was answered. In various embodiments, a user accessing the interactive video may ask verbal or text questions or select from a list of pre-defined questions.

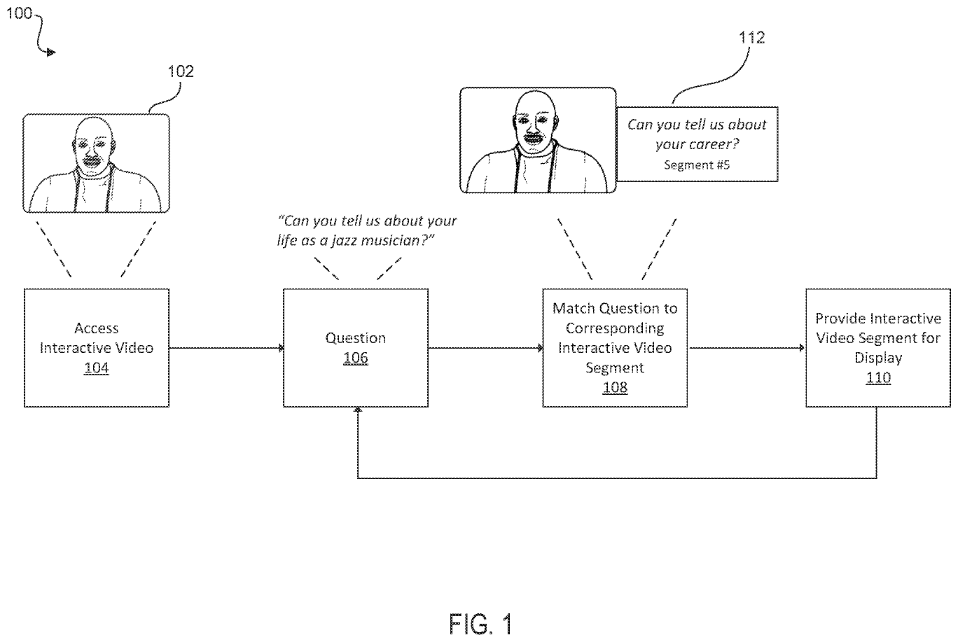

For example, FIG. 1 illustrates an example diagram 100 for accessing and querying an interactive video 102. In step 104, a user may access the interactive video 102 via an interactive video player. For example, the interactive video player may be included in a graphical user interface (GUI) provided by the AI-assisted interview system.

In step 106, the user accessing the interactive video 102 may ask a question (e.g., “Can you tell us about your life as a jazz musician?”). The question may be submitted verbally via an audio input device (e.g., microphone), as a text message in a chat interface, or as a selection from a list of questions provided in the interactive video player.

In step 108, the AI-assisted interview system may match the question to a segment of the interactive video 102 that is responsive to the question. In the example of FIG. 1, the question is matched to a segment 112 (e.g., Segment #5) of the interactive video 102, during which the requested question (or a variant thereof) was answered.

In step 110, the matched segment 112 may be provided for display in the interactive video player. The interactive video player may play the segment 112 for the user. Upon viewing the segment 112, the user may ask another question via the interactive video player. Similarly, a segment of the interactive video 102 that is responsive to that question may be identified and provided for display. The approaches described herein, therefore, allow the user to chat with the interactive video as if the user were engaging with the interviewee in a live setting.

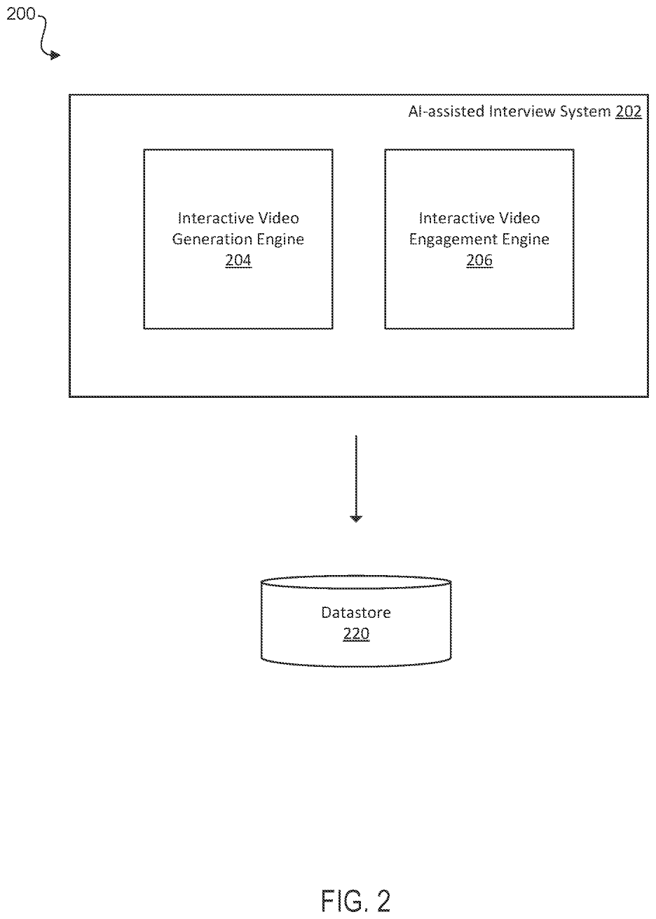

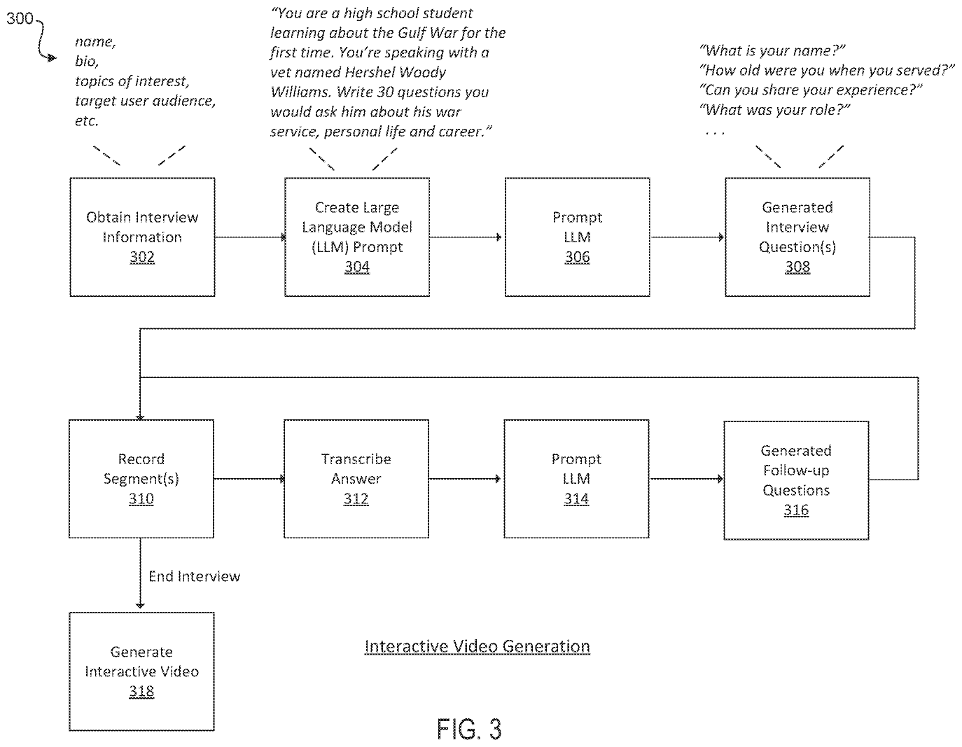

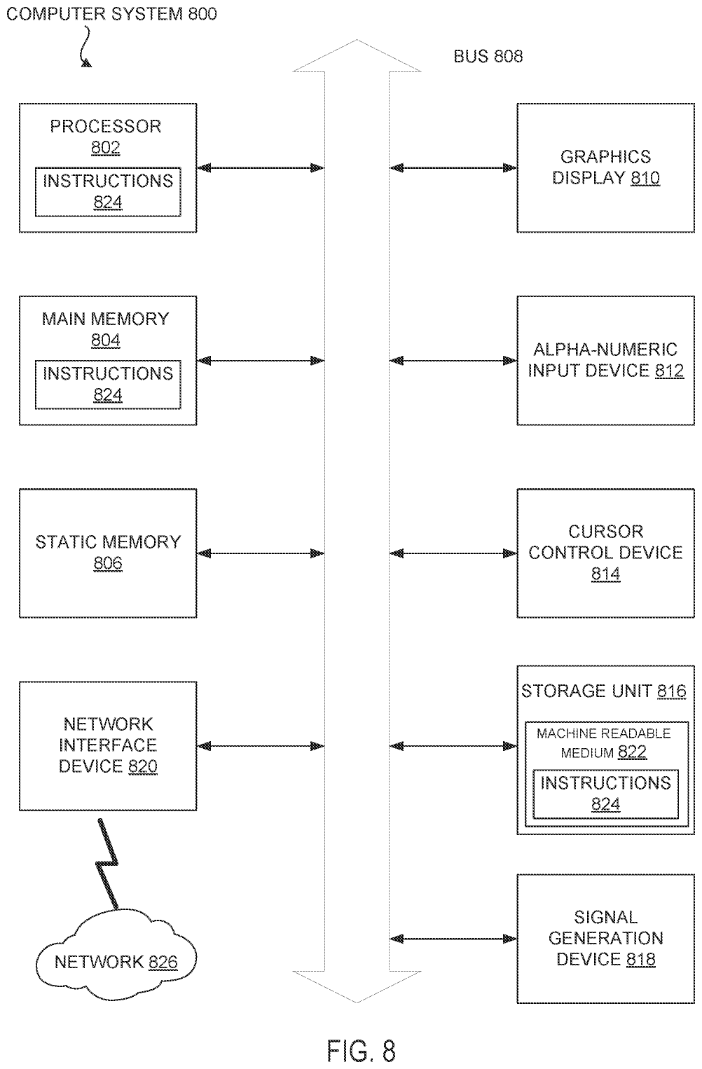

FIG. 2 depicts a block diagram 200 of components of an artificial intelligence (AI) assisted interview system 202 according to some embodiments. The AI-assisted interview system 202 may be implemented in a computer system that includes at least one processor, memory, and communication interface, as illustrated in FIG. 8. The computer system can execute software that performs any number of functions described in relation to FIGS. 3-7.

The AI-assisted interview system 202 includes an interactive video generation engine 204 and an interactive video engagement engine 206. The AI-assisted interview system 202 can access a datastore 220, for example, to access various data, such as stored interactive videos and other data, such as corresponding transcripts and related information (e.g., documents, videos, etc.). The AI-assisted interview system 202 may be implemented as a digital device or as a cloud-based platform.

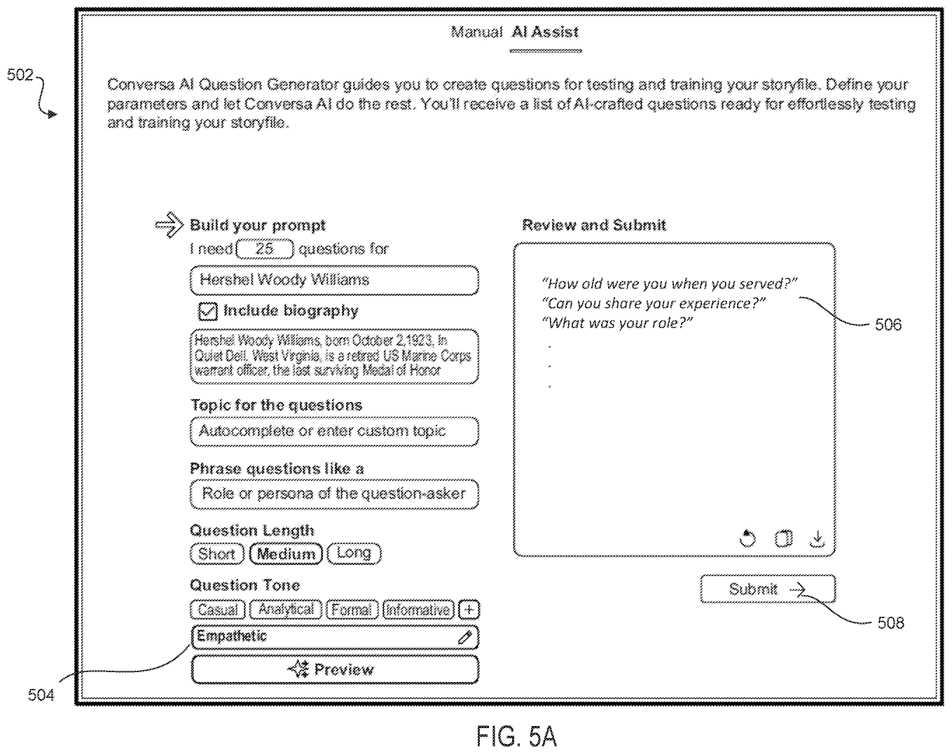

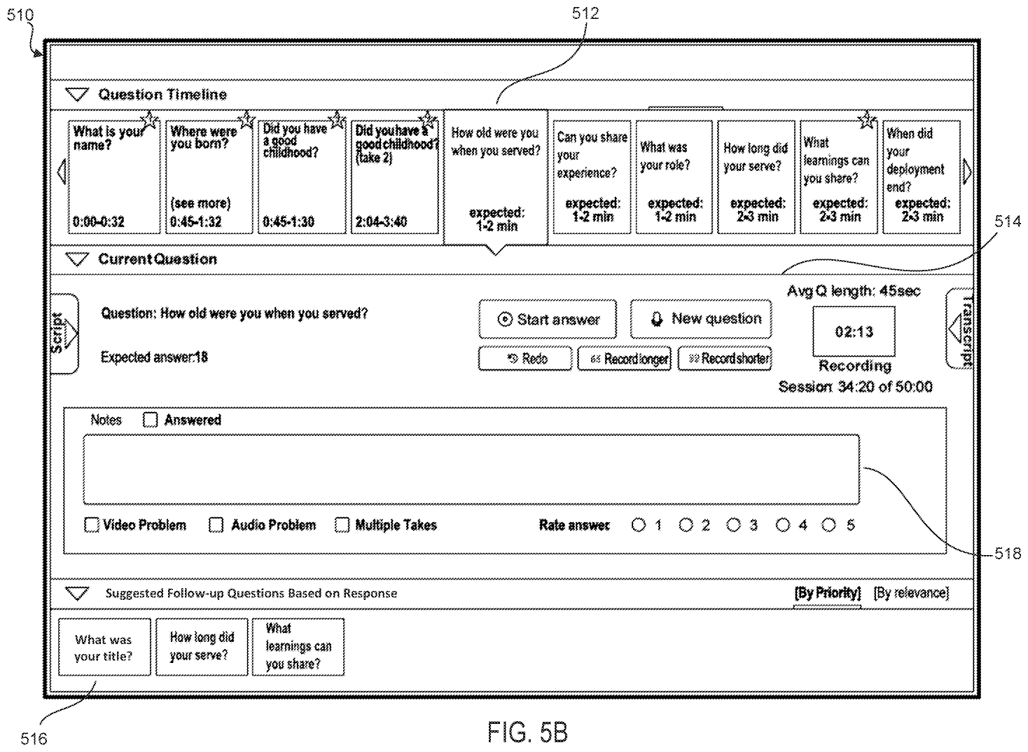

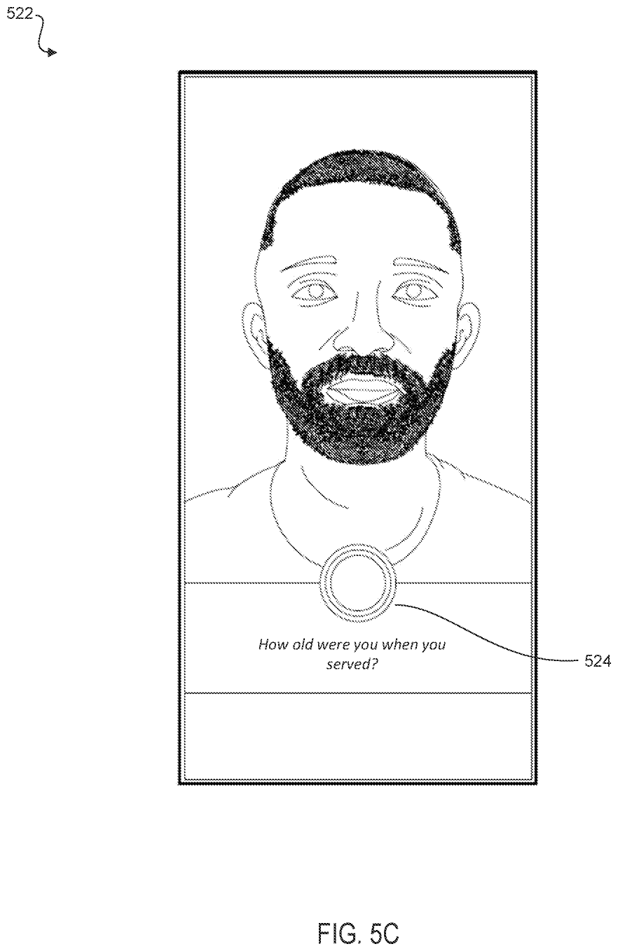

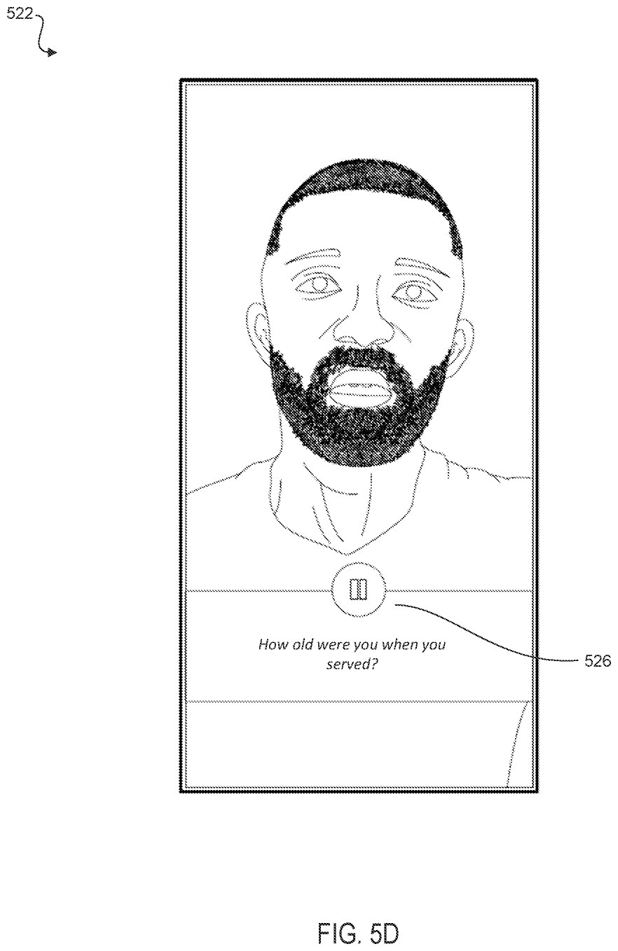

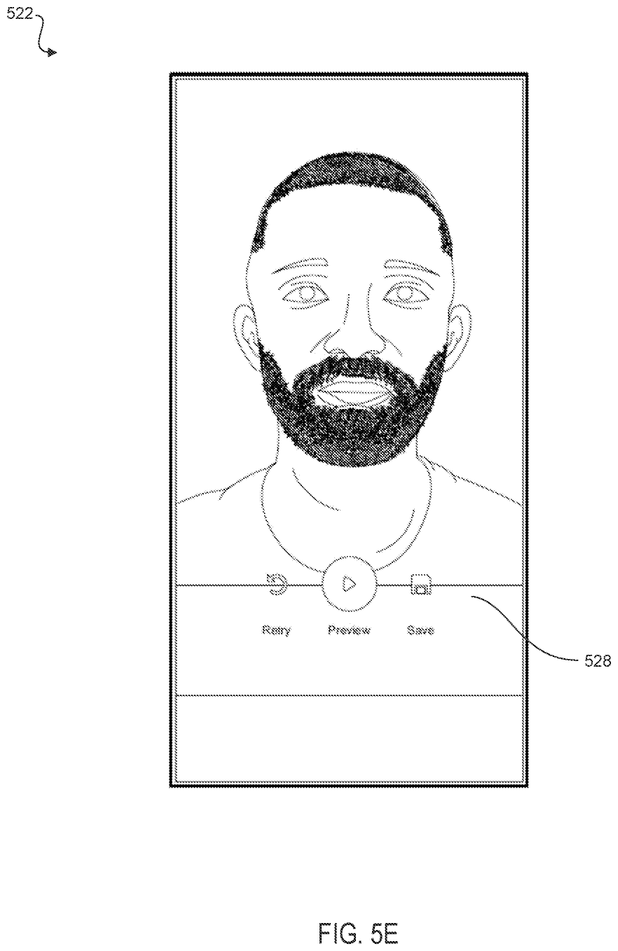

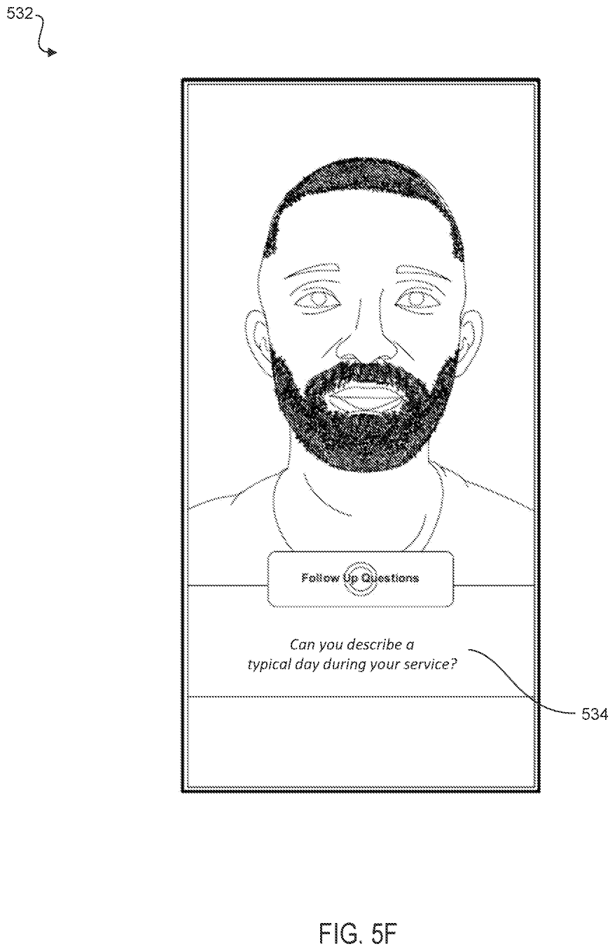

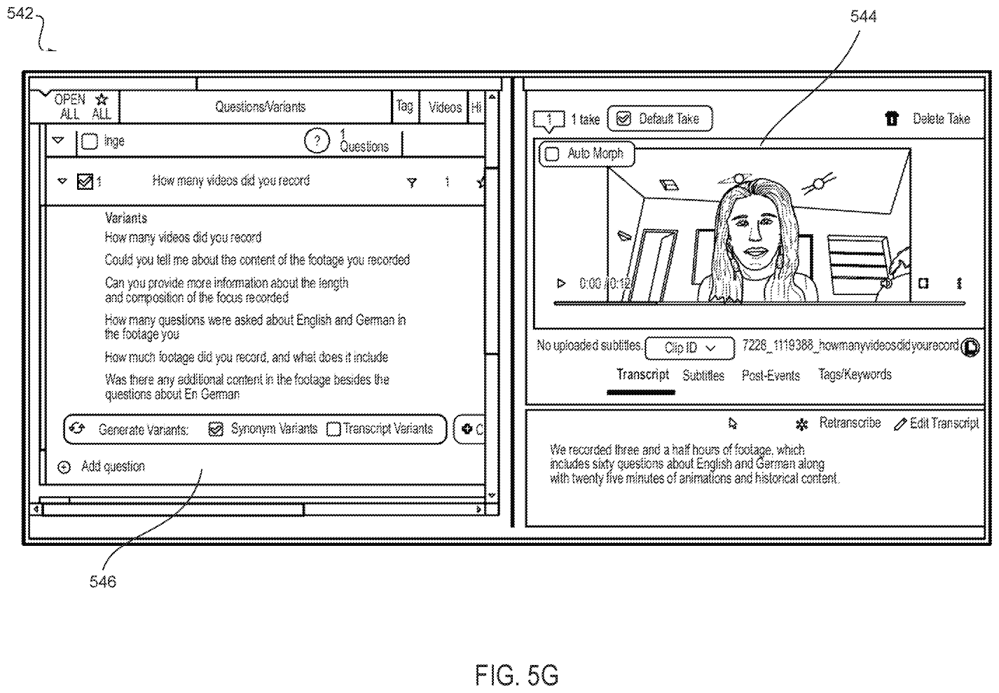

The interactive video generation engine 204 may be configured to create and generate interactive videos. For example, the interactive video generation engine 204 may provide interfaces that facilitate the creation and generation of interactive videos. The interfaces may be graphical user interfaces (GUIs) that may be presented on display screens of digital devices. For example, the interactive video generation engine 204 may generate and provide graphical user interfaces, as discussed in reference to the examples of FIGS. 5A-5G.

The interactive video generation engine 204 may facilitate communication between a user and the AI-assistance interview system 202. The interactive video generation engine 204 may translate user inputs, such as mouse clicks or keyboard strokes, into commands that the AI-assistance interview system 202 may evaluate or perform. The interactive video generation engine 204 may also render graphical elements of GUIs, such as buttons, menus, and windows, and update them accordingly.

To facilitate discussion, various operations performed by the interactive video generation engine 204 are discussed in reference to FIG. 3, a block diagram of an example approach for generating an interactive video.

In step 302, the interactive video generation engine 204 may obtain interview information. Based on the interview information, the interactive video generation engine 204 may automatically generate questions to be asked of an interviewee during an interview. For example, the interactive video generation engine 204 may generate questions for the interview based on contextual information, including the interviewee name, biography, topics of interest, target user audience, number of questions to be generated, question length, question tone, among others. In various embodiments, a user may provide such contextual information through a graphical user interface, as illustrated in the example of FIG. 5A.

FIG. 5A illustrates an example GUI 502 that may be provided by the interactive video generation engine 204. The GUI 502 may provide fields and options to input the contextual information, including interviewee name, biography, topics for questions, and how questions should be phrased in terms of role or persona, for example. The GUI 502 may also provide options for specifying parameters, such as question length (e.g., short, medium, long) and tone (e.g., casual, analytical, formal, informative). The GUI 502 may provide an option 504 that allows the user to specify a custom question tone to be used for generating questions.

The GUI 502 may also provide a field 506 to specify questions to be asked during the interview in addition to any questions that are automatically generated by the interactive video generation engine 204. In some embodiments, rather than specifying questions individually, a user may select script questions from a library of preexisting questions and topics. In some embodiments, relevant questions presented during other interview sessions and conversations—either with the same interviewee or a different interviewee—may be identified and recommended by the interactive video generation engine 204. For example, the interactive video generation engine 204 may identify such relevant questions based on a semantic search that returns questions that satisfy the contextual information provided in step 302. In some embodiments, the semantic search is performed using a vector database, such as the Pinecone vector database.

The interactive video generation engine 204 may generate questions in view of the specified or otherwise selected questions to avoid duplicative or redundant questions. Once the contextual information and related details are provided, the user may select a submit option 508 to instruct the interactive video generation engine 204 to generate questions for the interview.

As used herein, an interview may refer to any situation that involves one or more interviewers who engage in a dialogue with one or more interviewees by asking a series of questions. For example, an interview may be conducted for purposes of documenting the life story and experiences of a particular individual. In another example, an interview may be conducted for purposes of conducting a deposition. Further, the interviewer and interviewee may be the same person or different people. Many variations are possible.

In step 304, the interactive video generation engine 204 may generate a large language model (LLM) prompt. The LLM prompt may be provided to a LLM to generate a list of questions to be asked during the interview.

An LLM is a type of generative artificial intelligence model that learns patterns and connections between words and phrases by analyzing vast amounts of data. Generally, LLMs are exposed to massive amounts of text data to learn the patterns and connections between words, and to predict the next word in a sequence. Once trained, LLMs can be prompted to generate content based on user parameters, such as completing a partial sentence, answering a question, or translating text. Prompting LLMs involves providing them with a specific input or instruction, which the model uses to generate a relevant output.

The interactive video generation engine 204 may generate the LLM prompt based on the contextual information provided for the interview in step 302. For example, the LLM prompt may be generated based on the name and biography of the interviewee, topics of interest, target user audience, number of questions to be generated, question length, question tone, among others. In some embodiments, the LLM prompt may be generated by prompting the LLM to create another prompt that generates the list of questions based on the contextual information and related details provided. For example, the interactive video generation engine 204 may generate the following prompt:
You are a high school student learning about the Gulf War for the first time. You're speaking with a vet named Hershel Woody Williams. Write 30 questions you would ask him about his war service, personal life and career.

In various embodiments, similar question generation prompts can be generated procedurally by inserting available information into a formula. In one example:

Act as a <PERSONA>. Generate <NUMBER> of <SCRIPT QUESTIONS, FOLLOW-
UP QUESTIONS or SCRIPT ANSWERS>for <SUBJECT NAME>,, use <TOPIC> as a
topic. Refer to this content <DOCUMENTS>. For use with a group of <AUDIENCE>
in a <TARGET LOCATION> setting>.
Use <SAMPLE QUESTIONS> as reference.

It will be appreciated that sample question and responses can be provided as part of the prompt to provide concrete examples of question format, tone, and/or subject matter.

Generated questions can be used to initialize the questions script prior to the interview, or to supplement the question list during the interview process. For example, during the interview process in Step 314, the transcript of the most recent question response and other related question transcripts may be provided to further guide the question generation to a specific topic.

In step 306 and 314, the interactive video generation engine 204 may provide the generated prompt to a LLM for evaluation. In general, any LLM may be used for purposes of generating questions for the interview. For example, the LLM may be a well-known frontier LLM, such as ChatGPT and Claude. In another example, the LLM may be based on open-source LLM architectures, such as LLaMA, Mistral, or Falcon. When prompting the LLM, the interactive video generation engine 204 may provide the generated prompt as input to the LLM, which the LLM may then use to generate the questions.

The LLM model weights may be trained on a general-purpose corpus or fine-tuned for a specific domain and topic. For example, training data could be included to refine a model based on medical, law, history, or science data. In some embodiments, the model could be refined based on a specific business brand and documentation, or based on the individual or group of people. These models can be referred to as a specific language (SLM) model to accommodate a subject domain or a Tiny Language Model (TLM) related to the specific individual.

In some embodiments, the interactive video generation engine 204 may incorporate information from additional digital content such as text documents, websites, images, videos and other multimedia files to generate interview questions. For example, in step 302 the interviewer could upload a book covering the interview subject, a personal or business website, a lecture, presentation, or tutorial. The digital content (e.g., a reference document or other digital asset) may be tokenized into smaller sections and provided as part of the LLM prompt to generate questions in step 304.

In various embodiments, the digital content tokens may be encoded as semantic vectors in a database for later search. During the interview process, the interview assistant may generate more in-depth questions using, for example, retrieval augmented generation (RAG) document retrieval techniques. In some implementations, the engine identifies relevant text in the digital content (e.g., reference documents) by performing a similarity search between the encoded transcript response with encoded digital content sections. This matched document text can be added to the question generation prompt in step 314 to provide in-depth follow-up questions.

In some embodiments, the interactive video generation engine 204 uses retrieval-based methods to identify and suggest questions without the direct use of an LLM during steps 308 and 316. The interactive video generation engine may include a database of preexisting questions and topics. This database may include historical questions submitted for prior interviews and/or use semantic encoding to match the response transcript to questions in the database. These questions may be used directly in the interview or used as part of an LLM prompt to further refine the question tone and language for a specific interview.

It will be appreciated that the interactive video generation engine 204 may incorporate human generated questions. The interviewer may add their own questions prior to the interview (step 302) and/or during the interview process (step 316). The interactive video generation engine may include a digital messaging system where other users can submit potential follow-up questions to a given response from their own digital devices.

In various embodiments, human-generated questions include questions submitted to the interactive video engagement engine 206. In step 402, end-users interact with previously recorded content on the same or similar subject. In step 404, the interactive video engagement engine stores and clusters these responses for inclusion in future interviews. Questions that are repeated more often and do not have matching responses may be given higher priority by the ranking algorithm.

In step 308 and 316, these multiple sources of questions may be optionally combined to generate more complex questions and feedback using a Chain of Thought process. This process uses the questions or content output from one data source as input to a secondary data source. For one example, the interviewee states that they were a veteran in World War 2. Given this transcript, the LLM may generate a follow-up question asking where they served. By searching the transcripts of previous responses, the system may determine that the interviewee already provided related information, and that some or all of the related information may be appended to the LLM prompt and used to generate more precise follow-up questions. Alternatively, the initial LLM generated question may be used to search digital content to provide additional details about that event. Subsequently, all or some of the additional details may be appended to a new LLM search to generate more detailed questions.

In step 308, the interactive video generation engine 204 may obtain the list of interview questions generated by the LLM or in response to the prompt provided in step 306. The interactive video generation engine 204 may provide the generated questions in a GUI, as illustrated in the example of FIG. 5B.

FIG. 5B illustrates an example GUI 510 that may be provided by the interactive video generation engine 204. The GUI 510 may provide the questions generated by the LLM in a region of the GUI 510 that corresponds to a question timeline 512. For example, the question timeline 512 may arrange the questions chronologically in the order the questions could be asked by the interviewer. Each question may be shown with additional relevant information, such as an estimated amount of time for the interviewee to answer the question. For questions that have already been asked, the question timeline 512 may be updated to reflect the actual amount of time used by the interviewee to answer the question.

In various embodiments, the GUI 510 may be accessed by the interviewer when conducting the interview. The interviewer may refer to the questions provided in the question timeline 512 to determine which question to ask next.

When a question is ready to be asked, the GUI 510 may provide options and information related to the question to be asked (e.g., “Current Question”) in a region 514. For example, the region 514 may provide options to record (e.g., “Start Answer”) and re-record (e.g., “Redo”) an answer that is provided by the interviewee in response to the question.

The GUI 510 may provide additional options to manage the recording, such as reducing the recording or extending the recording, for example, to decrease or increase the amount of time that is allotted for the interviewee to answer. The region 514 may also provide functionality that allows the interviewer to add notes about the answer provided by the interviewee, to rate the answer, and to flag any issues with the answer (e.g., “Video Problem”, “Audio Problem”, “Multiple Takes”).

Once a question is answered, the interviewer may select an option (e.g., “New Question”) in the region 514 to proceed to the next question included in the question timeline 512. Alternatively, rather than proceeding linearly in accordance with the question timeline 512, the interviewer may adapt the interview by asking one or more suggested follow-up questions 516 that may be provided in the GUI 510.

In step 310, the interactive video generation engine 204 may record (or capture) a segment (or take) that corresponds to a video recording of the interviewee while answering the question. An interactive video (or storyfile) may comprise a series of segments (or takes).

In some embodiments, the interactive video engagement engine 206 may record a segment (or take) that may include one or more different multimedia formats. The recording could include, for example, audio-only recording, text-entry of responses, or supplemental recording of digital screenshots. Existing videos or media may also be uploaded or linked as part of a question response.

In various embodiments, when recording a segment, the interactive video generation engine 204 may provide a GUI 522 that facilitates visualization of the interviewee while responding to the question, as illustrated in the example of FIG. 5C. The GUI 522 may provide a digital representation of the interviewee as captured by a video capture device (e.g., camera, webcam, etc.) while the interviewee is responding to the question. The GUI 522 may reproduce the question being asked in text. The GUI 522 may also provide options, such as an option 524 to start a recording of the response.

In another embodiment, FIG. 5G illustrates another example GUI 542 that may be provided by the interactive video generation engine 204. The GUI 542 allows the interviewer to visualize the interviewee in a region 544 while responding to questions. The GUI 542 includes another region 546 in which questions (or variants of the questions) for the interview may be viewed and generated.

After the recording is underway, the GUI 522 may provide an option 526 to pause or stop the recording of the response, as illustrated in the example of FIG. 5D. The recording may be stopped after the interviewee finishes answering.

After the recording is stopped, the GUI 522 may provide additional options 528 for managing the recording, as illustrated in the example of FIG. 5E. The options 528 may include an option to re-record the answer (e.g., “Retry”), an option to preview the recording, and an option to save the recording as a segment (or take), for example.

In step 312, once a video recording of the interviewee answering the question is saved as a segment, the interactive video generation engine 204 may transcribe the recording to text. For example, the interactive video generation engine 204 may apply conventional automatic speech recognition techniques to analyze the audio track of the video recording and convert the spoken words to text, for example, using machine learning algorithms. As a result, the interactive video generation engine 204 may generate (or obtain) a transcription of the video recording in text format.

In step 314, the interactive video generation engine 204 may prompt the LLM for one or more follow-up questions based on the answer provided by the interviewee. For example, the interactive video generation engine 204 may generate a prompt that requests some number of follow-up questions based on the answer provided by the interviewee. In this example, the transcription of the video recording may be included in the prompt provided to the LLM to better tailor and improve the relevancy of the follow-up questions generated by the LLM.

In step 316, the interactive video generation engine 204 may obtain a list of follow-up questions generated by the LLM in response to the prompt provided in step 314. The interactive video generation engine 204 may provide the generated follow-up questions in a GUI, as discussed supra in reference to FIG. 5B. FIG. 5G illustrates another example GUI 532 in which one or more follow-up questions 534 may be provided.

In step 316, the interactive video generation engine 204 may provide other suggestions and feedback based on the recorded content. This feedback may be generated by the LLM or other AI algorithms based on analysis of the transcript, audio, and/or video and may include word choice, visual non-verbal communication, speech patterns, and/or audio quality. The feedback step may include text suggestions as well as synthesized audio, and/or video. The feedback step may also replay segments of the recorded content and/or highlight timecodes that correspond to the suggestions.

The interactive video generation engine 204 facilitates recording of additional segments 310 in which the interviewee answers other questions asked by the interviewer. In various embodiments, the interactive video generation engine 204 may identify any topics or talking points that may have been missed while conducting the interview. For example, the interactive video generation engine 204 may compare transcriptions of answers provided by the interviewee against pre-defined talking points specified by the interviewer in advance of the interview. In some embodiments, the comparison may be performed based on a semantic search that evaluates semantic vector encodings of the transcriptions of answers provided by the interviewee against semantic vector encodings of the pre-defined talking points. Based on this comparison, the interactive video generation engine 204 may provide a list of topics or talking points that have yet to be covered. Based on this list, the interviewer may decide to record more segments in which the interviewee answers additional questions to provide a more thorough interview.

In various embodiments, the interactive video generation engine 204 may analyze transcriptions of answers provided by the interviewee to determine speech and language properties. For example, the interactive video generation engine 204 may apply conventional natural language processing (NLP) techniques to determine properties, such as emotional tone, sentiment, filler words, and ambiguities.

In some embodiments, when a negative emotional tone is determined for an answer provided by the interviewee, the interactive video generation engine 204 may generate and provide questions that have been re-phrased in view of the negative emotional tone to help elicit more positive responses. For example, the re-phrased questions may be generated by prompting an LLM to re-phrase the original list of questions in view of the negative emotional tone.

In some embodiments, when filler words are detected, the interactive video generation engine 204 may suggest alternative language to aid the interviewee. For example, if a determination is made that the interviewee is struggling to answer a question, the interactive video generation engine 204 may generate hints or suggestions to help the interviewee formulate better answers. The hints or suggestions may be generated by prompting an LLM to provide hints or suggestions to help an interviewee formulate an answer to the question being asked. For example, the LLM may rephrase the transcript to be more formal or empathetic. Depending on the implementation, the hints or suggestions may be provided in a GUI that is accessible to the interviewer who then communicates them to the interviewee or in a GUI that is accessible to the interviewee. The interviewee or interviewer may select or add a defined tone. The corresponding LLM prompt may include the original transcript, set of tone modifiers, and/or talking points to generate a rewritten transcript.

In some embodiments, when ambiguity is detected, the interactive video generation engine 204 may provide clarification suggestions. For example, the interactive video generation engine 204 may apply conventional NLP techniques, such as word sense disambiguation (WSD), named entity disambiguation (NED), syntactic analysis, and semantic analysis to determine ambiguity in language. These techniques can help identify words or phrases that have multiple possible meanings or interpretations, which can be used to provide clarification suggestions to improve the clarity and accuracy of interviewee responses. Depending on the implementation, the clarification suggestions may be provided in a GUI that is accessible to the interviewer who then communicates them to the interviewee or in a GUI that is accessible to the interviewee.

In some embodiments, the AI engine analyzes the recorded audio and speech patterns. This process may include, for example, analyzing the volume, pitch, timbre, and/or tempo of the speech to improve enunciation and clarity. The audio classifier, in some embodiments can be trained on labeled audio based on clarity, enunciation, expressivity, and/or confidence. The classifier may check if enunciated words correspond with key talking points.

In some embodiments, the AI tracks facial features to recover eye gaze and/or facial expression. This information may optionally be used to provide feedback if the interviewee does not maintain consistent eye contact with the camera or if facial expression does not match the desired content.

Given one or more identified audio, video, and/or text issues, a corrective suggestion may be selected from a set of prescription suggestions or customizations using the LLM to generate a feedback with appropriate tone. In some embodiments, suggested feedback is presented on a teleprompter display (or any digital screen) to guide the interviewee during the recording process. For example, this could include active feedback to slow down, look at the camera. This guidance may also include suggested response text and/or high level talking points.

In some embodiments, the interactive video generation engine 204 may prioritize or rank questions. It may not be possible to display all suggested questions at once, or questions need to be prioritized based on limited interview time. For example, in some embodiments, questions may be prioritized based on specific questions that have been flagged by the interviewer as being important. In some embodiments, questions may be ranked based on their value. For example, a question value may be determined as follows:

$$Question Value = ( Interviewer Value + Audience Value ) / Confidence Covered$$

The Interviewer Value may be determined based on a question being marked as important by the interviewer either in pre-production or during recording of the interview. The Audience Value may be determined based on a list of audience questions, as determined either from survey data, chat logs, or a generative list. The generative list may include questions generated from prompts to the LLM and questions generated from transcript. The Confidence Covered represents a likelihood of the question having already been covered during the interview. The Confidence Covered may be determined based on a semantic search using a semantic vector encoding of the question and semantic vector encodings determined from a transcript of questions that have already been answered during the interview.

In some embodiments, the interactive video generation engine 204 may cluster questions based on topic. Such clustering may facilitate asking questions on a topic-by-topic basis and help ensure that the interviewee has answered at least one question for every topic. Questions and topics may be manually labeled by the interviewer or determined by a conventional clustering algorithm.

In some embodiments, questions that have already been answered may be removed from the list of questions provided to the interviewer. For example, the interactive video generation engine 204 may evaluate transcriptions of previous responses by the interviewee in view of questions that still need to be asked. In this example, the interactive video generation engine 204 perform the evaluation based on a semantic search to analyze interview transcriptions and determine whether a question has been answered by the interviewee. This approach involves using natural language processing (NLP) algorithms to identify the meaning and context of words and phrases in the transcriptions. By analyzing the semantic relationships between words and phrases, the interactive video generation engine 204 may identify instances where the interviewee has provided an answer to a question, even if the exact words used in the question are not present in the response. This can be particularly useful in situations where the interviewee may have provided an answer in a roundabout way or used different phrasing than the question.

In some embodiments, the interactive video generation engine 204 may apply semantic search techniques to identify instances where the interviewee may have avoided answering a question or provided an incomplete response. In such embodiments, the interactive video generation engine 204 may provide suggestions to the interviewer to follow up as needed.

In some embodiments, the interactive video generation engine 204 may estimate time remaining for questions as the interview progresses. For example, the interactive video generation engine 204 may estimate time remaining for questions as a weighted average of response times to similar historical questions. In some embodiments, the weighted average may be scaled to accommodate varying speech. For example, the interactive video generation engine 204 may scale the average based on a relative speech rate and verbosity of the interviewee.

For example, to estimate time remaining, the interactive video generation engine 204 may identify semantic matches from previous interviews for all questions answered in this interview. The interactive video generation engine 204 may compute a percentile for a number of words and a number of minutes. For remaining questions, the interactive video generation engine 204 may determine a historical length and predict expected time using average percentile. The average percentile could be weighted based on confidence, e.g., how close the question matches historical questions. As the interview progresses and more data is gathered, the interactive video generation engine 204 may more accurately predict the interviewee's speech patterns and verbosity.

In some embodiments, historical questions that are answered in an interview may be segmented (e.g., first 20%, middle 60%, last 20% of interview), since interviews often start slow and are rushed at end. The interactive video generation engine 204 may provide higher weight to questions that appear in similar stage of the interview. The interactive video generation engine 204 may detect if prior questions have specific time instructions (e.g., please answer in 1 minute or less). In some embodiments, LLMs may be prompted to generate draft answers to help estimate predicted response length.

In step 318, once all segments of the interview have been recorded, the interactive video generation engine 204 generates an interactive video of the interviewee. The interactive video may comprise a series of segments that each represent a video recording of the interviewee while answering a given question.

In some embodiments, the interactive video generation engine 204 may generate an index for the interactive video based on questions answered during the interview. For example, the interactive video generation engine 204 may identify questions and their corresponding timestamps in a transcription of the interview. The transcription can be analyzed using semantic search algorithms to identify the questions and their variations. For example, the index may map a segment, one or more semantic vector encodings of questions answered during the segment, and a timestamp corresponding to the segment in the interactive video. The index can be used to generate a table of contents or a searchable database for the interactive video.

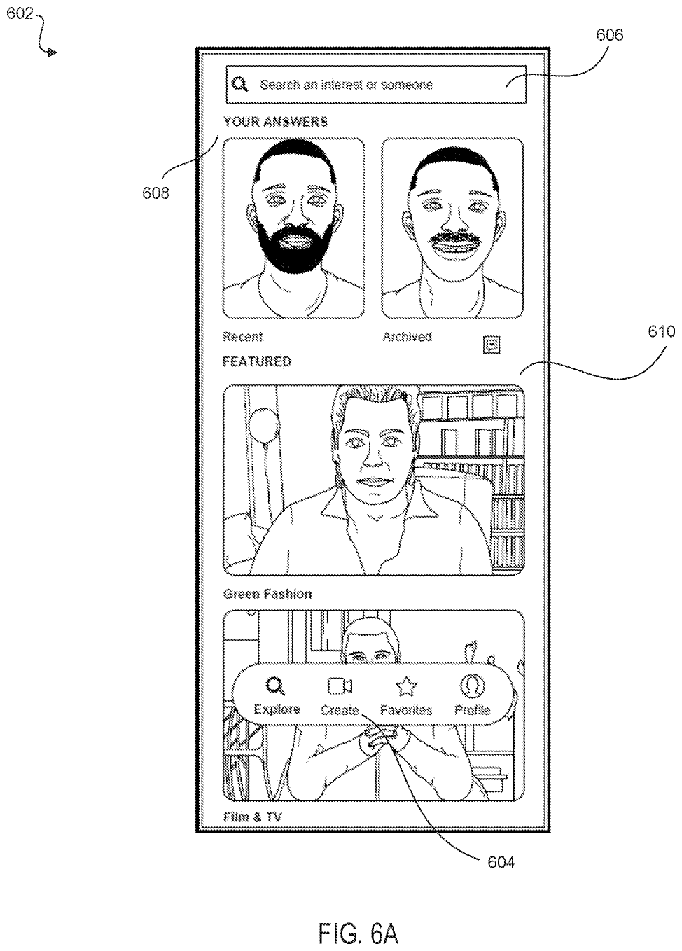

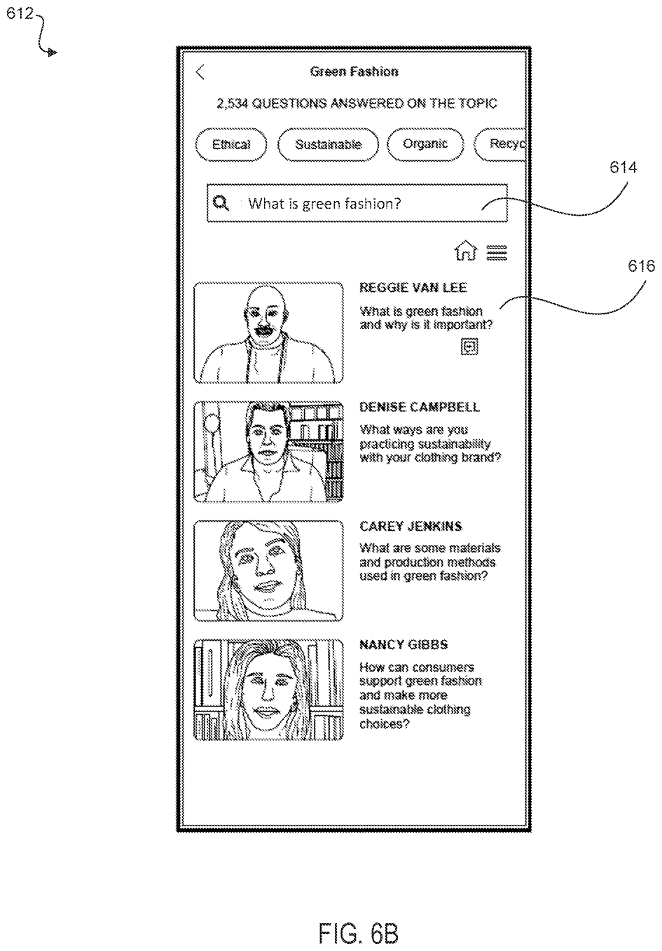

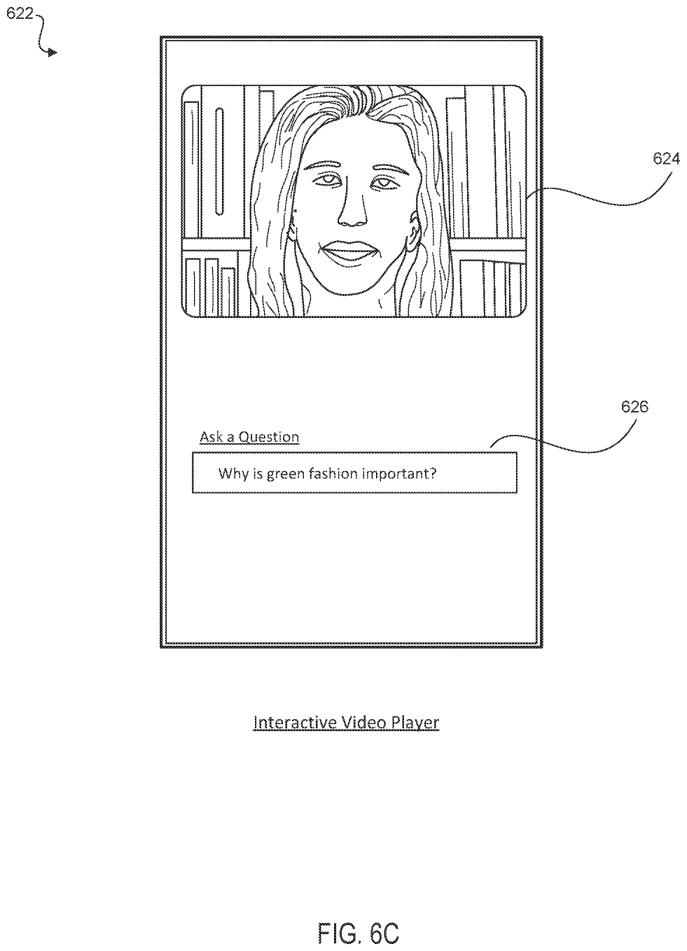

The interactive video engagement engine 206 may be configured to facilitate user interaction with interactive videos. For example, the interactive video engagement engine 206 may provide interfaces that facilitate interaction with interactive videos, for example, by asking questions. The interfaces may be graphical user interfaces (GUIs) that may be presented on display screens of digital devices. For example, the interactive video engagement engine 206 may generate and provide graphical user interfaces as illustrated and discussed in reference to the examples of FIGS. 6A-6C.

The interactive video engagement engine 206 may facilitate communication between a user and the AI-assistance interview system 202. The interactive video engagement engine 206 may translate user inputs, such as mouse clicks or keyboard strokes, into commands that the AI-assistance interview system 202 may perform or execute. The interactive video engagement engine 206 may also render graphical elements of GUIs, such as buttons, menus, and windows, and update them accordingly.

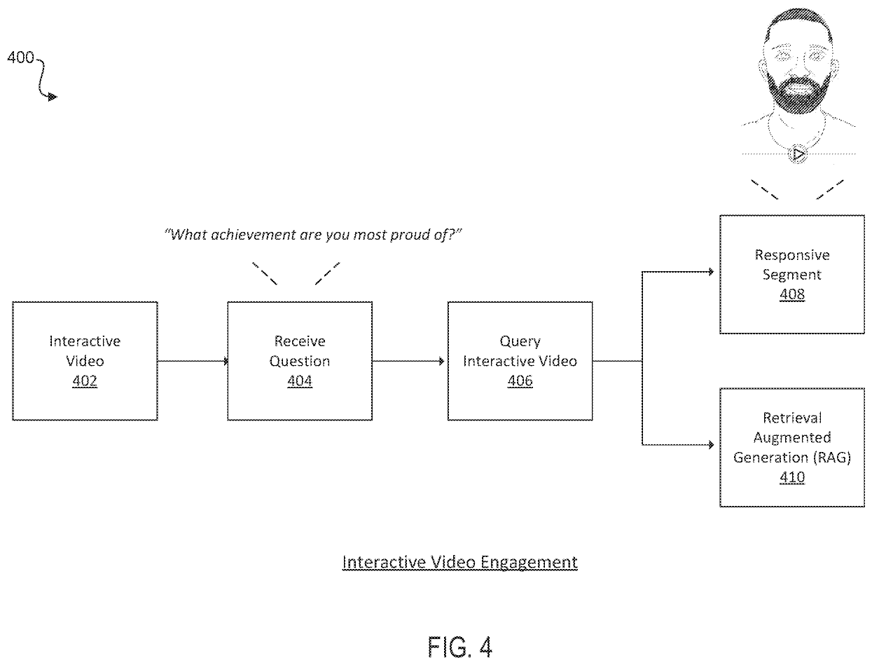

To facilitate discussion, various operations performed by the interactive video engagement engine 206 are discussed in reference to FIG. 4, a block diagram of an example approach for engaging with an interactive video.

In step 402, the interactive video engagement engine 206 may access an interactive video. For example, the interactive video may be selected by a user who is interested in learning more about a particular interviewee or topic.

In various embodiments, interactive videos may be accessible from an online platform. The online platform may provide access to a collection of interactive videos that capture different interviewees who share their insights on various topics, as shown in the example GUI 602 of FIG. 6A. Users may interact with the GUI 602 to create and share interactive videos of themselves or others through the online platform. For example, the GUI 602 may provide an option 604 to create and upload new interactive videos that may be published and shared with others through the online platform. Interactive videos that are created by the user of the GUI 602 may be shown in a region 608 (e.g., “Your Answers”) of the GUI 602. Interactive videos that are created by other users may be shown in a different region 610 of the GUI 602.

The GUI 602 may also provide search functionality 606 so users may locate interactive videos associated with a particular individual or topic. The user may input a search query that identifies a particular individual or topic. In response, the online platform may provide one or more interactive videos that are responsive to the search query. For example, FIG. 6B illustrates an example GUI 612 that provides a set of interactive videos 616 that are responsive to a search query 614 (e.g., “What is green fashion?”). Any of the search results be selected to access corresponding interactive videos. The interactive video engagement engine 206 may determine interactive videos based on a semantic search, as discussed herein.

Once an interactive video is selected, the interactive video engagement engine 206 may provide an interactive video player 622, as illustrated in the example of FIG. 6C. The interactive video player 622 may provide a region 624 in which video segments of the interactive video may be replayed in response to questions asked by the user.

In some embodiments, the interactive video engagement engine 206 may provide multimedia content in any number of formats, including, but not limited to, audio responses, text responses, static pictures, animated pictures, and/or graphics.

In step 404, the interactive video engagement engine 206 may determine that the user has provided a question. The user may input questions in a region 626 of the interactive video player 622. For example, the user may enter a question, “Why is green fashion so important?”. In some embodiments, questions may be asked by speaking into an audio capture device (e.g., microphone). In such embodiments, the interactive video engagement engine 206 may apply conventional speech-to-text techniques to convert the spoken questions to text. In some embodiments, the user may select from a list of pre-defined questions (or hints).

In step 406, the interactive video engagement engine 206 may search for video segments of the interactive video that are responsive to the question asked by the user. In various embodiments, the interactive video engagement engine 206 may semantically encode a text-based representation of the question. For example, the text-based representation of the question may be semantically encoded using natural language processing techniques, such as word embeddings and transformers. Word embeddings may represent words as dense vectors in a high-dimensional space, where the semantic relationships between words are captured by their spatial proximity. Transformers may use self-attention mechanisms to capture the contextual relationships between words in a sentence. By applying these techniques to a question and its variants, a semantic vector encoding can be obtained that captures the underlying meaning of the question.

The semantic vector encoding can then be used to match the question to a video segment of the interactive video. For example, in some embodiments, the interactive video engagement engine 206 may obtain an index associated with the interactive video. The index may provide a list of video segments associated with the interactive video, semantic vector encodings of questions that are answered in the video segments, and timestamps corresponding to the video segments. The semantic vector encoding of the question asked by the user may be matched to semantic vector encodings provided by the index to identify a video segment that is most responsive to the question asked by the user. For example, the interactive video engagement engine 206 may determine matches based on a cosine similarity between the semantic vector encoding of the question asked by the user and semantic vector encodings of questions that are answered in the video segments. As an example, a video segment associated with the shortest cosine-distance metric may be determined to be most responsive to the question asked by the user. In some embodiments, the matching may be performed by running multiple sentence embeddings in parallel to identify matches in both transcripts of video segments associated with the interactive video and question variants.

In step 408, the interactive video engagement engine 206 may provide the responsive video segment to be played. For example, the video segment may be played in the interactive video player 622, as described in reference to FIG. 6C.

In step 410, the interactive video engagement engine 206 applies retrieval augmented generation (RAG) document retrieval techniques if a match between the question asked by the user and a video segment cannot be determined. For instance, if a match between the question asked by the user and a video segment cannot be determined, then it is likely the interactive video does not have a video segment in which the question asked has been answered. In such instances, the interactive video engagement engine 206 applies RAG techniques to analyze any documents that are associated with the interactive video (e.g., news articles, biographies, websites, etc.) to potentially answer the question asked by the user. A text-based summary determined based on the documents may be provided to the user, for example, in the interactive video player 622.

In some embodiments, the interactive video engagement engine 206 may apply conventional deep learning technologies (e.g., deepfake technologies) to generate a synthetic video segment in which a likeness of the interviewee is digitally reproduced to appear as though the interviewee is speaking the text-based summary determined sing the RAG techniques. The interactive video engagement engine 206 may apply a deep neural network to generate a photo-realistic output video of the interviewee that is in sync with a generated voice of the interviewee speaking the text-based summary.

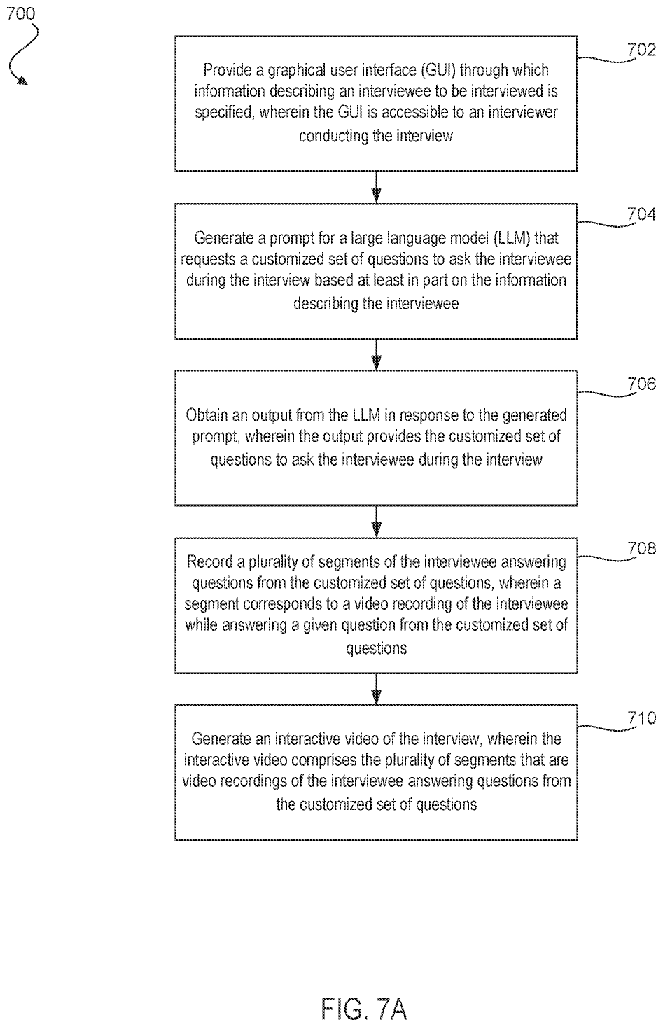

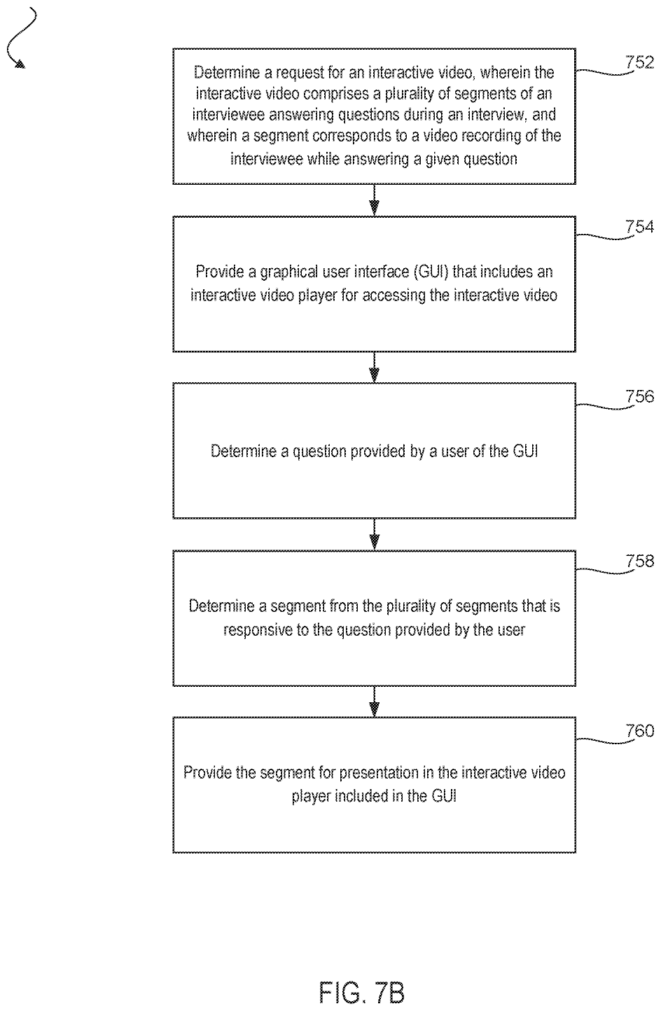

FIG. 7A illustrates an example process according to some embodiments. In step 702, a graphical user interface (GUI) through which information describing an interviewee to be interviewed is specified may be provided. The GUI may be accessible to an interviewer conducting the interview. In step 704, a prompt for a large language model (LLM) that requests a customized set of questions to ask the interviewee during the interview is generated based at least in part on the information describing the interviewee. In step 706, an output from the LLM in response to the generated prompt is obtained. The output provides the customized set of questions to ask the interviewee during the interview. In step 708, a plurality of segments of the interviewee answering questions from the customized set of questions are recorded. A segment may correspond to a video recording of the interviewee while answering a given question from the customized set of questions. In step 710, an interactive video of the interview is generated. The interactive video may comprise the plurality of segments that are video recordings of the interviewee answering questions from the customized set of questions.

FIG. 7B illustrates another example process according to some embodiments. In step 752, a request for an interactive video is determined. The interactive video may comprise a plurality of segments of an interviewee answering questions during an interview. A segment may correspond to a video recording of the interviewee while answering a given question. In step 754, a graphical user interface (GUI) that includes an interactive video player for accessing the interactive video is provided. In step 756, a question provided by a user of the GUI is determined. In step 758, a segment from the plurality of segments that is responsive to the question provided by the user is determined. In step 760, the segment is provided for presentation in the interactive video player included in the GUI.

FIG. 8 is a block diagram illustrating a digital device in one example. The digital device may read instructions from a machine-readable medium and execute those instructions by a processor to perform the machine processing tasks discussed herein, such as the engine operations discussed above. Specifically, FIG. 8 shows a diagrammatic representation of a machine in the example form of a computer system 800 within which instructions 824 (e.g., software) for causing the machine to perform any one or more of the methodologies discussed herein may be executed. In alternative embodiments, the machine operates as a standalone device or may be connected (e.g., networked) to other machines, for instance, via the Internet. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes a processor 802 (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 804, and a static memory 806, which are configured to communicate with each other via a bus 808. The computer system 800 may further include a graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or other pointing instrument), a data store 816, a signal generation device 818 (e.g., a speaker), and a network interface device 820, which also is configured to communicate via the bus 808.

The data store 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 826 via network interface 820.

While machine-readable medium 822 is shown in an example embodiment to be a single medium, the term “machine-readable medium” should be taken to include a single medium or multiple media (e.g., a centralized or distributed database or associated caches and servers) able to store instructions (e.g., instructions 824). The term “machine-readable medium” shall also be taken to include any medium that is capable of storing instructions (e.g., instructions 824) for execution by the machine and that causes the machine to perform any one or more of the methodologies disclosed herein. The term “machine-readable medium” includes, but should not be limited to, data repositories in the form of solid-state memories, optical media, and magnetic media.

In this description, the term “engine” refers to computational logic for providing the specified functionality. An engine can be implemented in hardware, firmware, and/or software. Where the engines described herein are implemented as software, the engine can be implemented as a standalone program, but can also be implemented through other means, for example as part of a larger program, as any number of separate programs, or as one or more statically or dynamically linked libraries. It will be understood that the named engines described herein represent one embodiment, and other embodiments may include other engines. In addition, other embodiments may lack engines described herein and/or distribute the described functionality among the engines in a different manner. Additionally, the functionalities attributed to more than one engine can be incorporated into a single engine. In an embodiment where the engines as implemented by software, they are stored on a computer readable persistent storage device (e.g., hard disk), loaded into the memory, and executed by one or more processors as described above in connection with FIG. 8. Alternatively, hardware or software engines may be stored elsewhere within a computing system.

As referenced herein, a computer or computing system includes hardware elements used for the operations described here regardless of specific reference in FIG. 8 to such elements, including, for example, one or more processors, high-speed memory, hard disk storage and backup, network interfaces and protocols, input devices for data entry, and output devices for display, printing, or other presentations of data. Numerous variations from the system architecture specified herein are possible. The entities of such systems and their respective functionalities can be combined or redistributed.

1. A computer-implemented method comprising:
providing a graphical user interface (GUI) through which information describing an interviewee to be interviewed is specified, wherein the GUI is accessible to an interviewer conducting the interview;
generating a prompt for a large language model (LLM) that requests a customized set of questions to ask the interviewee during the interview based at least in part on the information describing the interviewee;
obtaining an output from the LLM in response to the generated prompt, wherein the output provides the customized set of questions to ask the interviewee during the interview;
recording a plurality of segments of the interviewee answering questions from the customized set of questions, wherein a segment corresponds to a video recording of the interviewee while answering a given question from the customized set of questions; and
generating an interactive video of the interview, wherein the interactive video comprises the plurality of segments that are video recordings of the interviewee answering questions from the customized set of questions.

2. The computer-implemented method of claim 1, wherein the GUI includes a form to specify at least one of: a name of the interviewee, a biography of the interviewee, topics of interest, a target user audience, a number of questions to be generated by the LLM, question length, or question tone.

3. The computer-implemented method of claim 1, wherein the prompt generated to request the customized set of questions from the LLM identifies at least a name of the interviewee, a biography of the interviewee, a topic of interest, a target user audience, and a number of questions to be generated by the LLM.

4. The computer-implemented method of claim 1, wherein the customized set of questions generated by the LLM are provided in the GUI, and wherein the GUI is accessible to the interviewer while conducting the interview.

5. The computer-implemented method of claim 1, wherein recording a plurality of segments of the interviewee answering questions from the customized set of questions comprises:
storing a segment associated with a question answered by the interviewee, wherein the segment corresponds to a video recording of the interviewee while answering the question;
generating a second prompt for the LLM that requests one or more follow-up questions to ask the interviewee in response to the question answered by the interviewee; and
obtaining a second output from the LLM in response to the second prompt, wherein the second output provides the one or more follow-up questions to ask the interviewee.

6. The computer-implemented method of claim 5, comprising:
determining a transcription of the segment,
wherein the second prompt to request the one or more follow-up questions includes at least the transcription of the segment associated with the question answered by the interviewee.

7. The computer-implemented method of claim 1, wherein recording a plurality of segments of the interviewee answering questions from the customized set of questions comprises:
determining a transcription of a segment, wherein the segment corresponds to a video recording of the interviewee while answering a question;
analyzing the transcription of the segment to determine a tone of the interviewee while answering the question;
determining, based on the tone of the interviewee, to re-phrase the customized set of questions;
generating a second prompt for the LLM that requests a re-phrasing of the customized set of questions based at least in part on the tone of the interviewee; and
obtaining a second output from the LLM in response to the second prompt, wherein the second output provides the customized set of questions that are re-phrased based on the tone of the interviewee.

8. The computer-implemented method of claim 1, wherein recording a plurality of segments of the interviewee answering questions from the customized set of questions comprises:
determining a transcription of a segment, wherein the segment corresponds to a video recording of the interviewee while answering a question;
analyzing the transcription of the segment to determine one or more ambiguities in the answer provided by the interviewee;
generating a second prompt for the LLM that requests one or more clarifying questions based at least in part on one or more ambiguities in the answer provided by the interviewee; and
obtaining a second output from the LLM in response to the second prompt, wherein the second output provides the one or more clarifying questions.

9. The computer-implemented method of claim 1, wherein recording a plurality of segments of the interviewee answering questions from the customized set of questions comprises:
storing a segment associated with a question answered by the interviewee, wherein the segment corresponds to a video recording of the interviewee while answering the question;
determining an amount of time remaining for the interview; and
ranking questions remaining in the customized set of questions based at least in part on the amount of time remaining for the interview.

10. The computer-implemented method of claim 1, wherein generating the interactive video of the interview comprises:
generating an index for the interactive video based on segments recorded during the interview, wherein the index maps a segment, one or more semantic vector encodings of questions answered during the segment, and a timestamp corresponding to the segment in the interactive video.

11. The computer-implemented method of claim 1, further comprising: identifying interviewee information from the interview, assessing digital content for data related to the interviewee information, generating at least one question based in part of the assessed digital content, and providing the at least one question to the interviewer.

12. A computer-implemented method comprising:
determining a request for an interactive video, wherein the interactive video comprises a plurality of segments of an interviewee answering questions during an interview, and wherein a segment corresponds to a video recording of the interviewee while answering a given question;
providing a graphical user interface (GUI) that includes an interactive video player for accessing the interactive video;
determining a question provided by a user of the GUI;
determining a segment from the plurality of segments that is responsive to the question provided by the user; and
providing the segment for presentation in the interactive video player included in the GUI.

13. The computer-implemented method of claim 12, wherein the question is provided as text in a field provided in the GUI.

14. The computer-implemented method of claim 12, wherein determining a segment from the plurality of segments that is responsive to the question provided by the user comprises:
determining a semantic vector encoding of the question provided by the user; and
matching the semantic vector encoding of the question provided by the user to a segment in the plurality of segments.

15. The computer-implemented method of claim 14, wherein matching the semantic vector encoding of the question provided by the user to a segment in the plurality of segments comprises:
accessing an index associated with the interactive video, wherein the index maps segments, one or more semantic vector encodings of questions answered during the segments, and timestamps corresponding to the segments in the interactive video; and
determining a shortest cosine similarity distance between the semantic vector encoding of the question provided by the user and a semantic vector encoding associated with the segment.

16. The computer-implemented method of claim 12, further comprising:
determining that no segments in the interactive video are responsive to the question provided by the user; and
generating a response to the question asked by the user based at least in part on a retrieval augmented generation (RAG) technique that attempts to answer the question based on digital content associated with the interactive video.

17. A system comprising at least one processor and memory storing instructions that cause the system to perform:
providing a graphical user interface (GUI) through which information describing an interviewee to be interviewed is specified, wherein the GUI is accessible to an interviewer conducting the interview;
generating a prompt for a large language model (LLM) that requests a customized set of questions to ask the interviewee during the interview based at least in part on the information describing the interviewee;
obtaining an output from the LLM in response to the generated prompt, wherein the output provides the customized set of questions to ask the interviewee during the interview;
recording a plurality of segments of the interviewee answering questions from the customized set of questions, wherein a segment corresponds to a video recording of the interviewee while answering a given question from the customized set of questions; and
generating an interactive video of the interview, wherein the interactive video comprises the plurality of segments that are video recordings of the interviewee answering questions from the customized set of questions.

18. The system of claim 17, wherein the prompt generated to request the customized set of questions from the LLM identifies at least a name of the interviewee, a biography of the interviewee, a topic of interest, a target user audience, and a number of questions to be generated by the LLM.

19. The system of claim 17, wherein recording a plurality of segments of the interviewee answering questions from the customized set of questions causes the system to perform:
storing a segment associated with a question answered by the interviewee, wherein the segment corresponds to a video recording of the interviewee while answering the question;
generating a second prompt for the LLM that requests one or more follow-up questions to ask the interviewee in response to the question answered by the interviewee; and
obtaining a second output from the LLM in response to the second prompt, wherein the second output provides the one or more follow-up questions to ask the interviewee.

20. The system of claim 17, wherein generating the interactive video of the interview comprises:
generating an index for the interactive video based on segments recorded during the interview, wherein the index maps a segment, one or more semantic vector encodings of questions answered during the segment, and a timestamp corresponding to the segment in the interactive video.
